(19) United States
(12) Patent Application Publication
(10) Pub. No.: US 2002/0102031 A1
(43) Pub. Date: Aug. 1, 2002

(54) Composition of an image

(76) Inventors: Anne Lafage, Aix-en-Provence (FR); Lien Nguyen-Phuc, Paris (FR); Jacky Talayssat, Chateauneuf (FR); Jean Gobert, Maisons Alfort (FR)

Correspondence Address: U.S. Philips Corporation, 580 White Plains Road, Tarrytown, NY, 10591, US

(21) Appl. No.: 10/032,991

(22) Filed: Dec. 26, 2001

(30) Foreign Application Priority Data
Dec. 28, 2000 (FR) 0017208

(51) Int. Cl. G06K 9/36

(52) U.S. Cl. 382/284

(57) ABSTRACT

The composition of an image [IM] comprises the step of mapping [MAP] a set of image sample values [SV] from a departure space [DEP] to an arrival space [ARR] in accordance with a geometrical transformation [T]. A zone in the departure space [ITL] is computed by applying the inverse geometrical transformation [T⁻¹] to a zone in the arrival space [TL] covering a group of image samples. A group of input values [IV] is established for the zone in the departure space [ITL]. The group of input values [IV] comprises Boolean values [BV]. A Boolean input value has a certain position (x_{d}, y_{d}) in the departure space and designates the other input values having the same position as being non-valid if the position is outside the set of image sample values [SV]. The group of image samples [TL] is composed from the group of input values [IV]. The Boolean values [BV] prevent the input values designated as being non-valid from contributing to an image sample.

### FIELD OF THE INVENTION

The invention relates to the composition of an image, comprising a step of mapping a set of image sample values from a departure space to an arrival space in accordance with a geometrical transformation. The invention may be used, for example, in a system for composing an image from a definition of a visual object as used in the MPEG4 field and a definition of a visual object as used in the 3D graphic field. (3D stands for three dimensions; MPEG is the abbreviation of Motion Picture Expert Group.)

### BACKGROUND OF THE INVENTION

It is possible to compose an image by scanning the image sample by sample. For each sample, one or several image sample values are selected by means of the inverse geometrical transformation. The sample is established from these selected values. For example, the sample is a weighted combination of the selected values.

### OBJECT AND SUMMARY OF THE INVENTION

It is an object of the invention to provide implementations at relatively low cost.

According to the invention, an image is composed in the following way. The composition comprises the step of mapping a set of image sample values from a departure space to an arrival space in accordance with a geometrical transformation. A zone in the departure space is computed by applying the inverse geometrical transformation to a zone in the arrival space covering a group of image samples. A group of image values is established for the zone in the departure space. The group of input values comprises Boolean values. A Boolean input value has a certain position in the departure space and designates the other input values having the same position as being non-valid if the position is outside the set of image sample values. The group of image samples is composed from the group of input values. The Boolean values prevent the input values designated as being non-valid from contributing to an image sample.

The invention takes the following aspects into consideration. It is possible that the zone in the departure space, which is obtained by the inverse geometrical transformation of the zone in the arrival space, does not entirely fall within the set of image sample values. In this case, the zone in the departure space comprises one or several positions for which there are no sample image values. In principle, it is possible to compute a padding value for each of these positions from the image sample values which are comprised in the zone. It is thus possible to establish a group of input values for the zone in the departure space, of which all the input values are entirely issued from the set of image sample values. However, the computation of one or several padding values during establishment of a group of input values requires a relatively large number of operations. In real-time implementations, these operations must be effected within a relatively short time, which requires relatively rapid circuits. In general, the more rapid a circuit, the more expensive it is.

According to the invention, the group of input values comprises Boolean values. A Boolean input value has a certain position in the departure space and designates the other input values having the same position as being non-valid if the position is outside the set of image sample values. During composition of the group of image samples, the Boolean values prevent the input values designated as being non-valid from contributing to an image sample. Consequently, it is not necessary to compute one or several padding values during the establishment of a group of input values. Such a computation may take place, for example, during the composition of the group of image samples, which, in general, requires fewer operations than a computation during the establishment of the group of input values. Consequently, the invention allows implementations with less rapid circuits so that the invention allows implementations at relatively low cost.

These and other aspects of the invention are apparent from and will be elucidated, by way of non-limitative example, with reference to the embodiment(s) described hereinafter.

### BRIEF DESCRIPTION OF THE FIGURES

FIGS. 1 and 2 are conceptual diagrams illustrating basic characteristics described hereinbefore;

FIG. 3 is a block diagram illustrating a device for composing an image;

FIG. 4 is a conceptual diagram illustrating the composition of an image;

FIG. 5 is a conceptual diagram illustrating a tile and an inverse tile associated therewith;

FIG. 6 is a conceptual diagram illustrating the generation of a tile;

FIGS. 7a, 7b and 7c are conceptual diagrams illustrating the generation of Boolean input values;

FIGS. 8a, 8b and 8c are conceptual diagrams illustrating the generation of Boolean input values;

FIG. 9 is a conceptual diagram illustrating the establishment of a contribution value;

FIG. 10 is a block diagram illustrating a processor which forms part of the device for composing an image, as illustrated in FIG. 3;

FIG. 11 is a conceptual diagram illustrating the operation of an internal control circuit which forms part of the processor illustrated in FIG. 10;

FIG. 12 is a conceptual diagram illustrating a surface of a 3D graphic element;

FIG. 13 is a block diagram illustrating some details of a shape former which forms part of the processor illustrated in FIG. 10;

FIGS. 14a, 14b, 14c and 14d are conceptual diagrams illustrating the operation of the shape former;

FIG. 15 is a conceptual diagram illustrating a conversion of the format in which the binary input values play a role; and

FIG. 16 is a table illustrating the operation of the processor illustrated in FIG. 10.

### DESCRIPTION OF PREFERRED EMBODIMENTS

The following remarks relate to the reference signs. Similar entities are defined by a reference by way of identical letters in all the Figures. Several similar entities may appear in a single Figure. In this case, a number or a suffix is added to the letter reference so as to distinguish the similar entities. The number or suffix may be omitted for reasons of convenience. This applies to both the description and the claims.

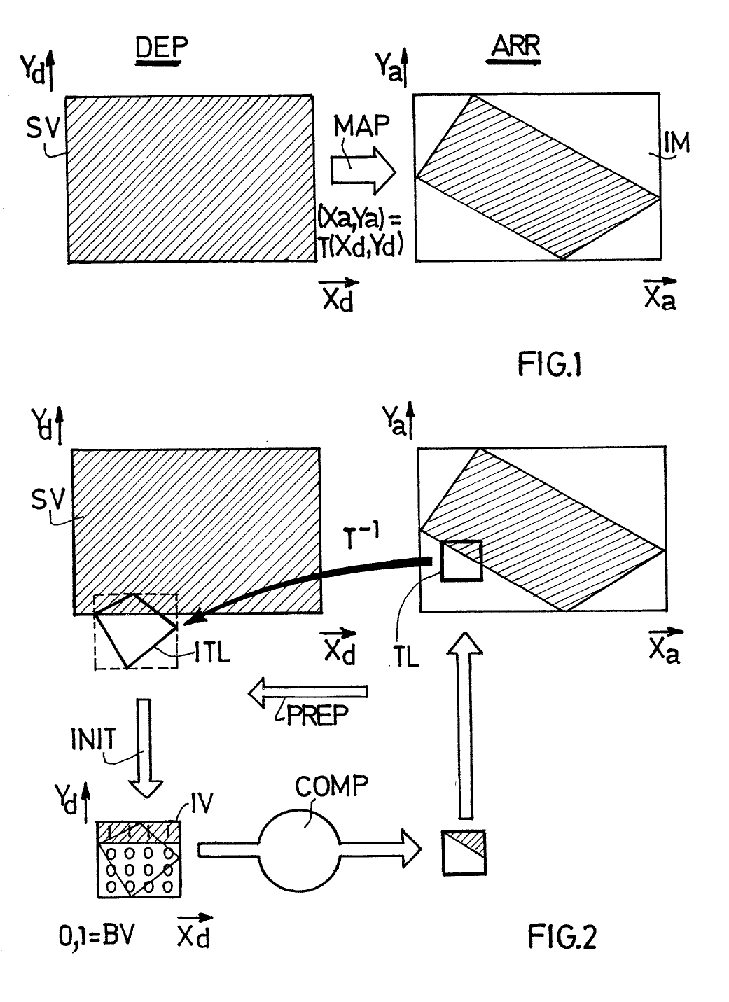

FIGS. 1 and 2 illustrate the basic characteristics described hereinbefore. FIG. I illustrates the composition of an image [IM]. Indeed, a set of image sample values [SV] is mapped [MAP] from a departure space [DEP] to an arrival space [ARR] in accordance with a geometrical transformation [T].

FIG. 2 illustrates three steps. In a preparation step [PREP], a zone in the departure space [ITL] is computed by applying the inverse geometrical transformation [T⁻¹] to a zone in the arrival space [TL] covering a group of image samples. In an initialization step [INIT], a group of input values [IV] is established for the zone in the departure space [ITL]. The group of input values [IV] comprises Boolean values [BV]. A Boolean input value has a certain position (x_{d}, y_{d}) in the departure space and designates the other input values having the same position as being non-valid if the position is outside the set of image sample values [SV]. In a composition step [COMP], the group of image samples [TL] is composed from the group of input values [IV]. The Boolean values [BV] prevent the input values designated as being non-valid from contributing to an image sample.

The characteristics illustrated in FIGS. 1 and 2 may be applied, for example, in a system for composing an image from a definition of a visual object as is used in the MPEG4 field and a definition of a visual object as is used in the 3D graphic field. It has already been mentioned that in the 3D graphic field a visual object is typically represented by a set of graphic elements in the form of triangles. A set of parameters defines the different characteristics of a graphic element, inter alia, its geometrical characteristics and its texture.

In the MPEG4 field, the definition of a visual object is typically in the form of a set of image sample values. There are different types of image sample values: luminance values (Y), chrominance values (U, V), opacity values (A) and Boolean values (S). The A values (opacity) are used for superimposing the visual object concerned on another visual object or on a background. The S values (Boolean) indeed constitute a definition of the shape of the visual object concerned, while the other values constitute a definition of the texture. A value from the set of image sample values will hereinafter be referred to as original value.

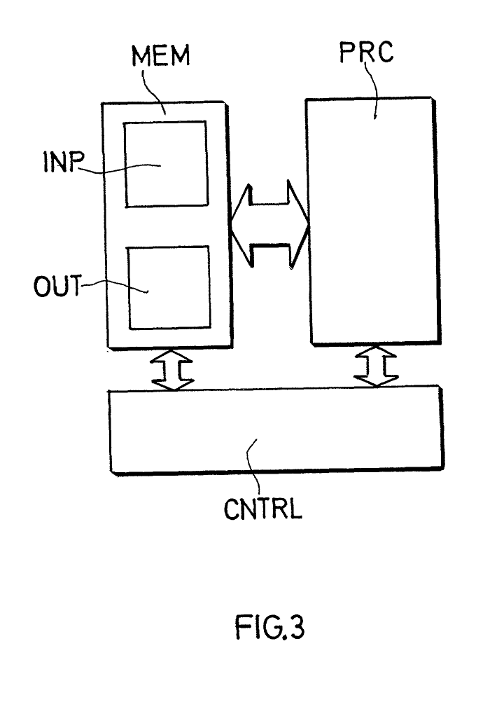

FIG. 3 illustrates a device for composing an image. The device comprises a memory [MEM], a processor [PRC] and a controller [CNTRL]. The memory [MEM] comprises an input section [INP] and an output section [OUT]. The input section [INP] is used for storing one or several definitions of the visual object. For example, the input section [INP] may comprise data resulting from a decoding operation in accordance with the MPEG4 standard and 3D graphic data. The input section [INP] thus typically comprises one or several sets of image sample values. The output section [OUT] is used for temporarily storing a composed image. This image may be read, for example, by a display device for display on a screen.

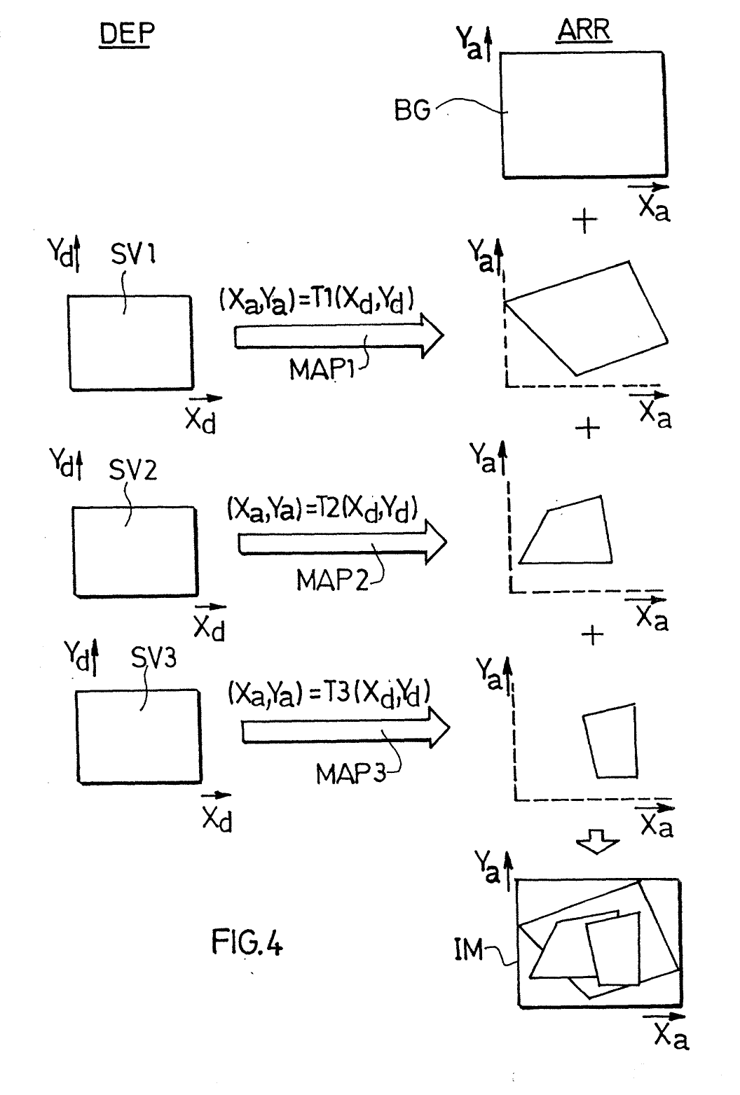

FIG. 4 illustrates in a conceptual manner how the device shown in FIG. 3 composes an image [IM] from three sets of image sample values [SV1, SV2, SV3].

The three sets of image sample values [SV] are indeed present in a 2D space, hereinafter referred to as departure space [DEP]. Each original value has a certain position in the departure space [DEP]. The position is defined by co-ordinates (x_{d}, y_{d}) in the horizontal and vertical dimensions. These co-ordinates (x_{d}, y_{d}) will hereinafter be referred to as departure co-ordinates. The processor [PRC] illustrated in FIG. 3 associates departure co-ordinates (x_{d}, y_{d}) with a memory address for storing an original value. The processor [PRC] thus also establishes the address, at which an original value is stored, from the departure co-ordinates (x_{d}, y_{d}).

The composed image [IM] is indeed present in a 2D space which will hereinafter be referred to as arrival space [ARR]. Each image sample has a certain position in the arrival space [ARR]. The position is defined by co-ordinates (xₐ, yₐ) in the horizontal and vertical dimensions. These co-ordinates (xₐ, yₐ) will hereinafter be referred to as arrival co-ordinates. The controller [CNTRL] illustrated in FIG. 3 associates the arrival co-ordinates (xₐ, yₐ) with a memory address for storing an image sample. The controller [CNTRL] thus also establishes the address, at which an image sample must be stored, from the arrival co-ordinates (xₐ, yₐ).

The processor [PRC] maps [MAP] each set of image sample values [SV] concerned from the departure space [DEP] to the arrival space [ARR]. The mappings [MAP] illustrated in FIG. 4 involve a geometrical transformation [T]. Moreover, the processor [PRC] superimposes, or blends, [BLND] the sets of mapped image sample values on a background [BG]. This means that several sets of image sample values may contribute to an image sample.

In FIG. 4, the sets of image sample values [SV] are represented by rectangles. This sufficiently characterizes their typical structure. However, the processor [PRC] may indeed trim a rectangle in order to obtain another shape which will be mapped from the departure space to the arrival space. For example, the processor [PRC] may trim a rectangle on the basis of geometrical parameters associated with the definition of a 3D visual object. In this case, the result will be a triangle which the processor [PRC] will map from the departure space to the arrival space. In any case, trimming a rectangle corresponds to defining a sub-set in the set of image sample values.

The device illustrated in FIG. 3 composes an image by successive generation of image sample blocks. An image sample block will hereinafter be referred to as “tile”. A tile may comprise, for example, 16×16 image samples. The processor [PRC] generates the tiles under the control of the controller [CNTRL]. The controller [CNTRL] establishes control parameters for each tile before the processor [PRC] starts generating tiles. This constitutes a preparation phase. Once the control parameters have been established, the controller [CNTRL] successively applies the control parameters to the processor [PRC] so that this processor successively generates the tiles. This constitutes an execution phase.

More particularly, in the preparation phase, the controller [CNTRL] first establishes a list of tiles constituting the composed image. For each tile, the controller [CNTRL] establishes a list of sets of image sample values which contribute to the tile. For each of these sets, the controller [CNTRL] computes an inverse tile. The inverse tile is obtained by means of an inverse geometrical transformation of the tile. The inverse geometrical transformation is the inverse of the geometrical transformation in accordance with which the set of image sample values concerned is mapped, as illustrated in FIG. 4.

FIG. 5 illustrates a tile [TL] and an inverse tile [ITL] associated therewith. The tile [TL] is present in the arrival space [ARR] whereas the inverse tile [ITL] is present in the departure space [DEP]. FIG. 5 illustrates a set of image sample values [SV] in the departure space [DEP] and the mapping of this set [SV] in the arrival space [ARR]. This mapping involves a geometrical transformation [T]. The inverse tile [ITL] is obtained by applying the inverse geometrical transformation [T⁻¹] to the tile [TL]. The inverse tile [ITL] illustrated in FIG. 5 is particular in the sense that it covers an edge of the set of image sample values.

The controller [CNTRL] establishes a rectangular box in the departure space which frames the inverse tile [ITL]. This box is illustrated in FIG. 5 by means of broken lines. At the useful instant, the controller [CNTRL] transfers a definition of the rectangular box in the form of control parameters to the processor [PRC]. These control parameters also comprise information on the presence of an edge, if any. In this respect, it should be noted that there are several types of edges. An edge may be, for example, an edge of the set of image sample values as illustrated in FIG. 5. An edge may also be an edge of a triangle obtained from the definition of a 3D graphic element.

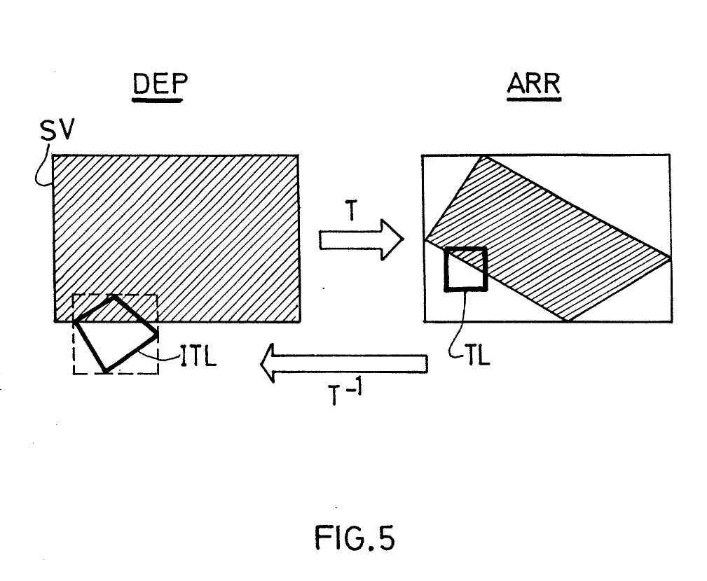

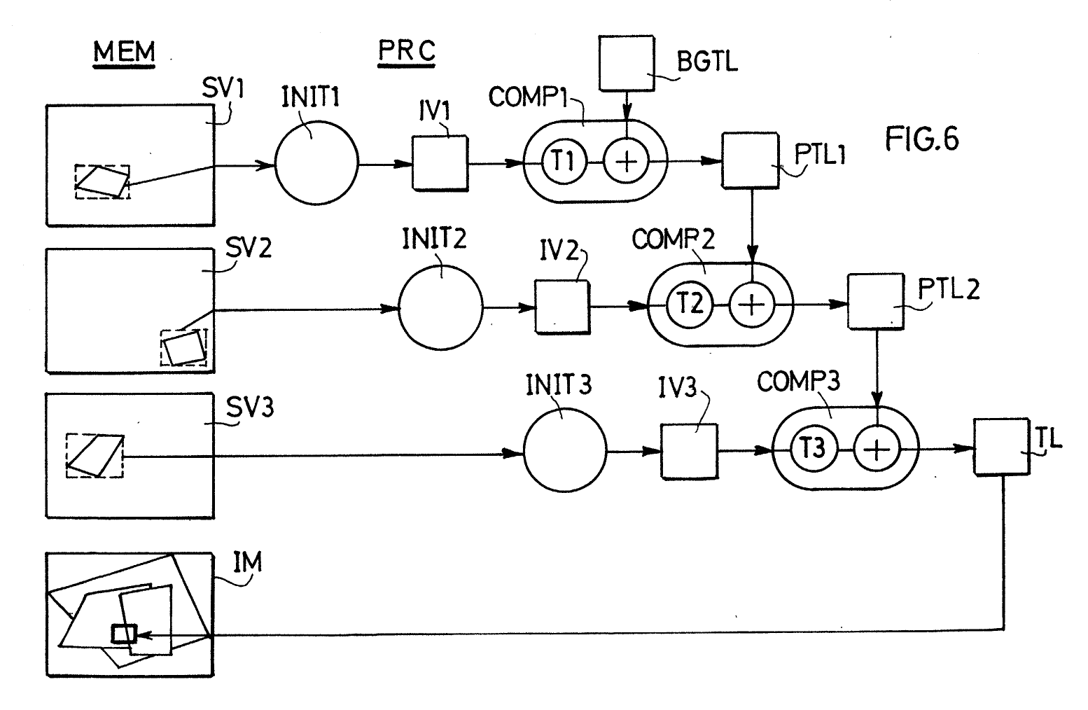

FIG. 6 illustrates how the processor [PRC] shown in FIG. 3 generates a tile [TL]. The tile [TL] is generated from three sets of image sample values [SV] enumerated first to third values [SV1, SV2, SV3]. The three sets of image sample values [SV] are present in the memory [MEM] shown in FIG. 3.

The processor [PRC] performs an initialization step [INIT] for each set of image sample values [SV] which contributes to the tile. The initialization step [INIT] leads to a block of input values [IV]. In a first initialization step [INIT1], the processor [PRC] thus creates a first block of input values [IV1] from the first set of image sample values [SV1]. In a second initialization step [INIT2], it creates a second block of input values [IV2] from the second set of image sample values [SV2]. In a third initialization step [INIT3], the processor [PRC] creates a third block of input values [IV3] from the third set of image sample values [SV3]. A block of input values [IV] represents a part of the set of image sample values [SV] concerned, required for generating the tile [TL]. The initialization steps [INIT] will hereinafter be described in greater detail.

The blocks of input values [IV] are present in the departure space [DEP] illustrated in FIGS. 4 and 5. Each input value has departure co-ordinates (x_{d}, y_{d}) defining its position in the departure space. There are different types of input values: luminance input values (Y), chrominance input values (U, V), opacity input values (A) and Boolean input values (S). The format of a block of input values [IV] is 4:4:4. This means that for each Y input value having a certain position (x_{d}, y_{d}) in the departure space, there is a U input value and a V input value having the same position (x_{d}, y_{d}). There is also an A input value (opacity) and a Boolean input value having this position (x_{d}, y_{d}). The Boolean input value indicates if the Y, U, V and A input values concerned must be taken into account in the composition step [COMP] subsequent to the initialization step [INIT]. This means that the Boolean input value indicates whether the Y, U, V and A input values concerned are valid or not.

The processor [PRC] performs a composition step [COMP] for each block of input values [IV]. In each composition step [COMP], the processor [PRC] indeed maps a part of the block of input values [IV] concerned from the departure space [DEP] to the arrival space [ARR]. This mapping involves the geometrical transformation [T] concerned as illustrated in FIG. 4. In the first composition step [COMP1], the processor [PRC] indeed maps a part of the first block of input values [IV1] and superimposes the result of this mapping above a background tile [BGTL]. The first composition step [COMP1] thus leads to a first intermediate tile [PTL1]. In the second composition step [COMP2], the processor [PRC] indeed maps a part of the second block of input values [IV2] and superimposes the result of this mapping above the first intermediate tile [PTL1]. The second composition step thus leads to a second intermediate tile [PTL2]. In the third composition step [COMP3], the processor [PRC] indeed maps a part of the third block of input values [IV3] and superimposes the result of this mapping above the second intermediate tile [PTL2]. The third composition step [COMP3] thus leads to the tile [TL]. The composition steps [COMP] will hereinafter be described in greater detail.

It will now be described in detail how the processor [PRC] creates a block of input values [IV] in an initialization step [INIT]. The processor [PRC] performs a reading operation in the memory [MEM]. This reading operation only concerns a rectangular zone in the departure space which frames the inverse tile [ITL] concerned. This rectangular zone will hereinafter be referred to as read zone. It is illustrated by means of the broken lines in FIG. 6.

Let it be assumed that the format of the set of image sample values concerned [IVS] is 4:4:4. Let it also be assumed that the read zone is sufficiently small so that the processor [PRC] can temporarily store all the original values which are present in the read zone. In this case, the Y, U, V and A input values are copies of the original Y, U, V and A values, respectively, in the read zone. Indeed, the processor [PRC] copies the read zone in an internal memory as far as the original Y, U, V and A values are concerned.

The processor [PRC] converts the format if the format of the set of image sample values concerned [IVS] is different from 4:4:4. For example, let it be assumed that the format of the set of image sample values [IVS] is 4:2:2. In this case, the processor [PRC] indeed creates a supplementary U value between two neighboring original U values. It also creates a supplementary V value between two neighboring original V values. A conversion of the format 4:2:2 to 4:4:4 thus involves an interpolation between two neighboring original U values and an interpolation between two neighboring original V values. If the format of the set of image sample values [IVS] is 4:2:0, the processor [PRC] performs an interpolation between four neighboring original U values and an interpolation between four neighboring original V values.

The processor [PRC] comprises an internal memory for temporarily storing a block of input values [IV]. This internal memory is relatively small. The read zone shown in FIG. 6 may be so large that the internal memory cannot store all the original values which are present in the read zone. In this case, the processor [PRC] indeed compresses the values. The processor [PRC] computes the average of N consecutive original Y values in order to obtain an Y input value, N being an integer representing a compression factor. If necessary, the processor compresses values similar to the original U, V and A values.

The processor [PRC] may have to convert the format and simultaneously compress values. In this case, the processor [PRC] adapts the previously described interpolation as a function of the compression factor (N). For example, let it be assumed that the compression factor (N) is 2 and the storage format in the memory [MEM] is 4:2:2. In this case, the processor [PRC] does not perform an interpolation between two original values. The resolution of the original U and V values in the set of image sample values [IVS] is already satisfactory: it is equal to the resolution obtained by the compression of the original Y values.

The processor [PRC] generates the Boolean input values from one or several definitions of edges, if any. If the set of image sample values concerned comprises original S values, the processor [PRC] also takes the original S values in the read zone into account.

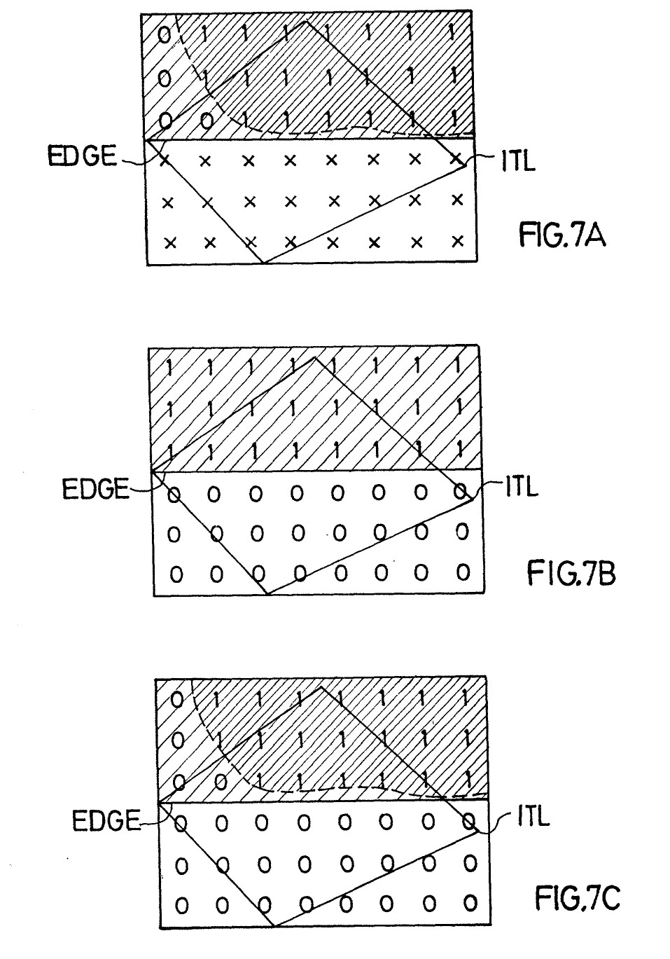

FIGS. 7a, 7b and 7c illustrate the generation of Boolean input values in a conceptual manner. Each Figure illustrates an inverse tile [ITL] which corresponds to that already shown in FIG. 5. The inverse tile [ITL] covers an edge [EDGE] of the set of image sample values concerned. A rectangle frames the inverse tile [ITL]. For simplifying the Figures, it is supposed that the rectangular box comprises 8 times 6 positions in the departure space.

FIG. 7a illustrates Boolean values established from the relevant set of image sample values. The set of image sample values comprises original S values for the positions above the edge [EDGE]. It is recalled that the original S values constitute a definition of the shape of a visual object. FIG. 7a illustrates a part of the contour of the visual object by means of a broken line. The set of image sample values does not comprise the original S values for the positions below the edge [EDGE]. Consequently, the Boolean values below the edge [EDGE] have do-not-care values [x].

FIG. 7b illustrates Boolean values established from the edge [EDGE] of the set of image sample values. The Boolean values above the edge [EDGE] are equal to one (1). They indicate that there are original values for these positions. In contrast, the Boolean values below the edge [EDGE] are equal to zero (0). They indicate that there are no original values for these positions.

FIG. 7c illustrates Boolean values obtained by combining FIGS. 7a and 7b in accordance with the logic AND function. This means that a Boolean value illustrated in FIG. 7c is the result of an AND combination of the Boolean value having the same position in FIG. 7a and that in FIG. 7b. The Boolean values illustrated in FIG. 7c represent the Boolean input values.

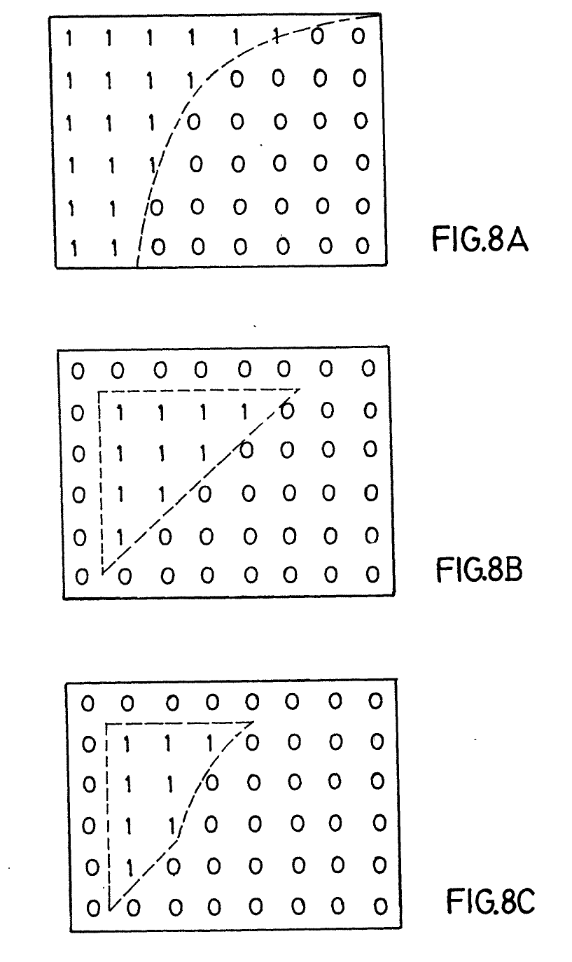

FIGS. 8a, 8b and 8c illustrate another generation of Boolean input values. These Figures do not show an inverse tile because, in principle, this does not play a role. It is supposed that the rectangular box does not comprise an edge of the relevant set of image sample values. In other words, the rectangular box is completely present in the relevant set of image sample values.

FIG. 8a illustrates Boolean values established from the relevant set of image sample values. The set of image sample values comprises original S values for all positions in the rectangular box. It is again recalled that these original S values constitute a definition of the shape of a visual object. FIG. 8a illustrates a part of the contour of the visual object by means of broken lines.

FIG. 8b illustrates Boolean values established from several edge definitions. These edge definitions are based on geometrical parameters of a 3D graphic element. There is a first edge [EDGE1], a second edge [EDGE2] and a third edge [EDGE3]. These edges [EDGE] define a triangle [TRNGL]. Each Boolean value in the triangle [TRNGL] is equal to one (1). Each Boolean value outside the triangle [TRNGL] is equal to zero (0).

FIG. 8c illustrates Boolean values obtained by combining FIGS. 8a and 8b in accordance with the logic AND function. This means that a Boolean value illustrated in FIG. 8c is the result of an AND combination of the Boolean value having the same position in FIG. 8a and that in FIG. 8b. The Boolean values illustrated in FIG. 8c represent the Boolean input values. In this example, a visual object whose shape is defined by means of the original S value is trimmed by means of several edge definitions associated with a 3D graphic element.

The operations performed by the processor [PRC] in the composition steps [COMP] will now be described in detail. In each composition step [COMP], the processor [PRC] indeed scans the zone in the arrival space [ARR] which occupies the tile [TL] as illustrated in FIG. 5. This zone comprises several positions characterized by arrival co-ordinates (xₐ, yₐ) in integers. The tile [TL] comprises a Y image sample, a U image sample and a V image sample for each position (xₐ, yₐ). For each position (xₐ, yₐ) the processor [PRC] establishes a Y contribution value, a U contribution value, a V contribution value, an A contribution value and an S contribution value. The processor [PRC] establishes these contribution values from the relevant block of input values [IV].

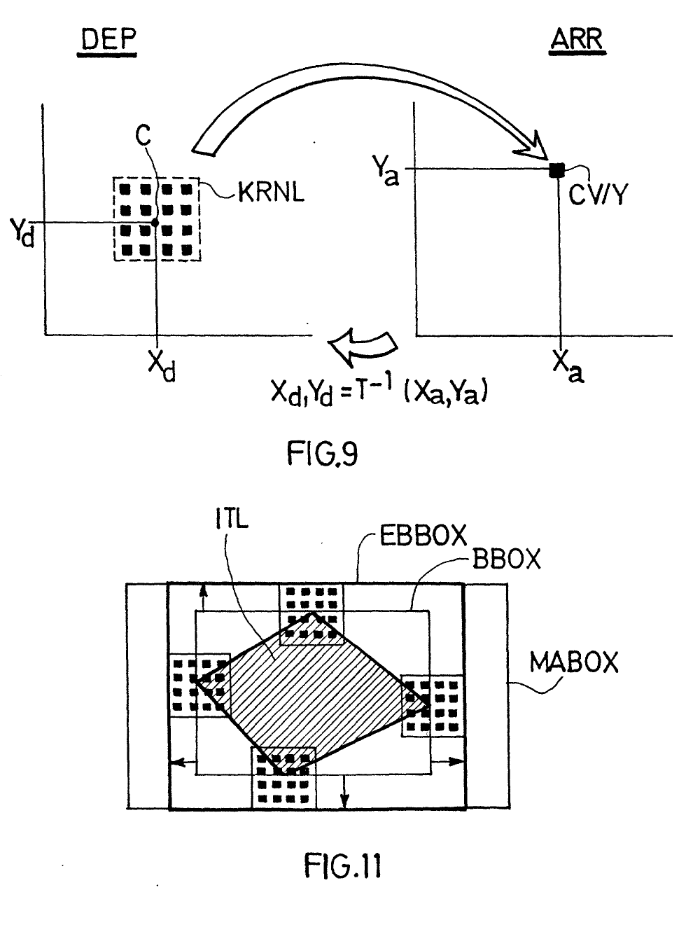

FIG. 9 illustrates how the processor [PRC] establishes a Y contribution value [CV/Y] for a position (xₐ, yₐ) in the arrival space [ARR]. The processor [PRC] computes departure co-ordinates (x_{d}, y_{d}) from arrival co-ordinates (xₐ, yₐ) of the position concerned. The departure co-ordinates (x_{d}, y_{d}) are obtained by applying the inverse of the geometrical transformation concerned [T⁻¹] to the arrival co-ordinates (xₐ, yₐ). The arrival co-ordinates (xₐ, yₐ) are integers while the departure co-ordinates (x_{d}, y_{d}) may be rational numbers. This means that the departure co-ordinates (x_{d}, y_{d}) may be decomposed into a part in integers (X_{d}′, y_{d}′) and a fractional part (Δx_{d}, Δy_{d}). The following relation applies: (x_{d}, y_{d})=(x_{d}′, y_{d}′)+(Δx_{d}, Δy_{d}), x_{d}′ and y_{d}′ being integral numbers, Δx_{d} and ΔY_{d} being rational numbers between 0 and 1.

FIG. 9 illustrates that the departure co-ordinates (x_{d}, y_{d}) constitute the center of a filter kernel [KRNL]. The size of the filter kernel [KRNL] illustrated in FIG. 9 is 4 times 4 positions. The filter kernel [KRNL] is present in the relevant block of input values [IV]. This implies that the filter kernel [KRNL] typically comprises 16 Y input values. It should be noted that one or several Y input values may be non-valid. It is recalled that the Boolean input values indicate which input values are valid and which are not.

The processor [PRC] establishes a weighted combination of the valid Y input values in the filter kernel [KRNL]. The weighting factors depend on the fractional part (Δx_{d}, Δy_{d}) of the departure co-ordinates (x_{d}, y_{d}). The weighted combination constitutes the Y contribution value [CV/Y]. The processor [PRC] establishes the U, V and A contribution values in accordance with the same method. The Boolean contribution value is typically the Boolean input value which is nearest to the center of the filter kernel [KRNL]. The Boolean contribution value indicates if the U, V and A contribution values must be subsequently taken into account.

In the first composition step [COMP1], illustrated in FIG. 6, the processor [PRC] scans the zone which occupies the tile [TL] in the arrival space as described hereinbefore. For each position (xₐ, yₐ), the processor [PRC] establishes Y, U, V and A contribution values and a Boolean contribution value from the first block of input values [IV1] as described with reference to FIG. 9.

If the Boolean contribution value indicates that the Y, U, V and A contribution values are valid, the processor [PRC] establishes weighted combinations of the Y, U and V contribution values with a Y, U and V background sample, respectively, originating from the background tile [BGTL] having the same position (xₐ, yₐ). The results of these weighted combinations constitute first Y, U and V intermediate samples. The A contribution value determines the weighting factors. If the Boolean contribution value indicates that the Y, U, V and A contribution values are not valid, the Y, U and V background samples originating from the background tile [BGTL] constitute first Y, U and V intermediate samples. The processor [PRC] thus establishes first Y, U and V intermediate samples for each position (xₐ, yₐ). At the end of the scanning operation, the set of first Y, U and V intermediate samples constitutes the first intermediate tile [PTL1] illustrated in FIG. 6.

In the second composition step [COMP2] and the third composition step [COMP3], illustrated in FIG. 6, the processor [PRC] essentially performs the same operations as in the first composition step [COMP1] described hereinbefore. In the second composition step [COMP2], the second block of input values [IV2] takes the place of the first block of input values [IV1]. The first intermediate tile [PTL1] takes the place of the background tile [BGTL] and the first intermediate samples thus take the place of the background samples. The processor [PRC] establishes second Y, U and V intermediate samples for each position (xₐ, yₐ). At the end of the scanning operation, the second Y, U and V intermediate samples constitute the second intermediate tile [PTL2] illustrated in FIG. 6.

In the third composition step [COMP3], the third block of input values [IV3] takes the place of the first block of input values [IV1] used in the first composition step [COMP1]. The second intermediate tile [PTL2] takes the place of the background tile [BGTL] and the second intermediate samples thus take the place of the background samples. The processor [PRC] establishes Y, U and V image samples for each position (xₐ, yₐ). At the end of the scanning operation, the Y, U and V image samples constitute the tile [TL] illustrated in FIG. 6.

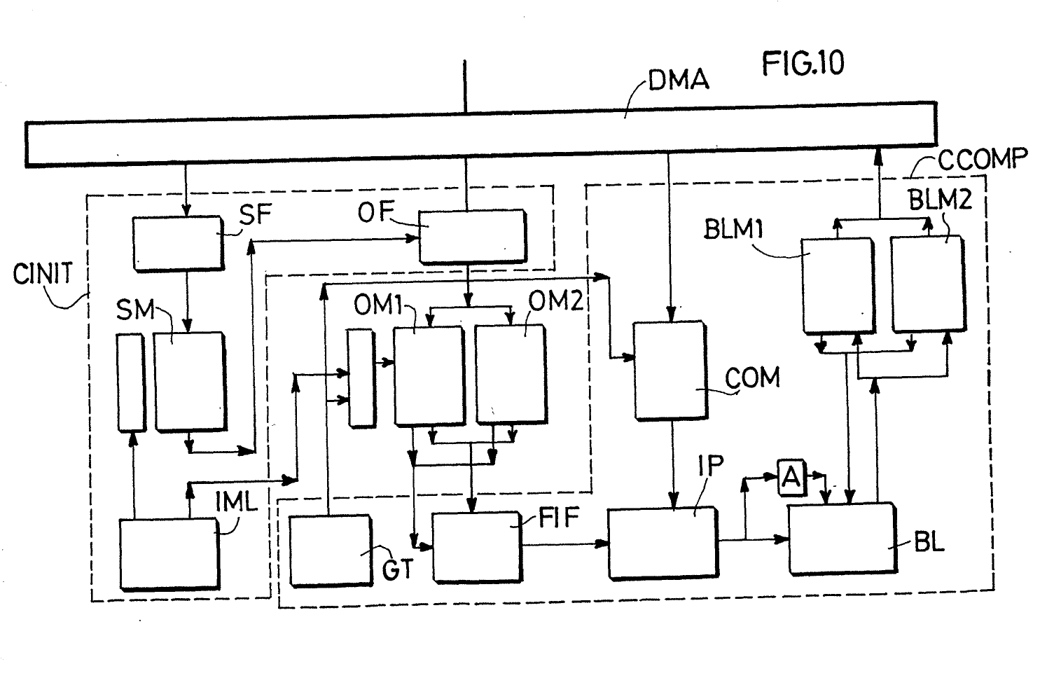

FIG. 10 illustrates the processor [PRC]. The processor [PRC] comprises a random access memory [DMA], an initialization circuit [CINIT], two object memories [OM] and a composition circuit [CCOMP]. More in detail, the initialization circuit [CINIT] comprises a shape former [SF], a shape memory [SM], an object former [OF] and an internal control circuit [IML]. The composition circuit [CCOMP] comprises a geometrical transformation circuit [GT], a filter shape former [FIF], a coefficient memory [COM], an interpolation circuit [IP] and a blending circuit [BL] and two blending memories [BLM]. The blocks without a reference sign near internal memories [SM, OM1, OM2] represent memory control circuits.

The initialization circuit [CINIT] performs the initialization steps [INIT] illustrated in FIG. 6. The two object memories [OM] are used for temporarily storing the blocks of input values [IV] shown in FIG. 6. The processor [PRC] makes an association between an address in the one and the other object memory [OM] and a position (x_{d}, y_{d}) in the departure space [DEP] illustrated in FIG. 4. The composition circuit [CCOMP] performs the composition steps [COMP] shown in FIG. 6. The two blending memories [BLM] are used for temporarily storing the background tile [BGTL], the first intermediate tile [PTL1], the second intermediate tile [PTL2] and the tile [TL]. The processor [PRC] makes an association between an address in the one and the other blending memory [BLM] and a position (xₐ, yₐ) in the arrival space [ARR] illustrated in FIG. 4.

FIG. 11 illustrates the operation of the internal control circuit [IML] shown in FIG. 10. The internal control circuit [IML] receives control parameters from the controller [CNTRL] illustrated in FIG. 3, which control parameters define a rectangular box [BBOX]. This rectangular box [BBOX] frames the inverse box [ITL] concerned, as explained hereinbefore with reference to FIG. 5.

The internal control circuit [IML] establishes an extended rectangular box [EBBOX] from the rectangular box [BBOX] and the filter kernel [KRNL] which is applied by the interpolation circuit [IP]. The term filter kernel [KRNL] has already been explained with reference to FIG. 9. The extended rectangular box [EBBOX] comprises all the values which may be comprised in the kernel by displacing the center of the filter kernel [KRNL] in the rectangular box [BBOX].

The internal control circuit [IML] extends the extended rectangular box [EBBOX] in order to obtain an aligned rectangular box [MABOX] having a standard size. The aligned rectangular box [MABOX] designates a certain zone in the departure space. The number of positions in this zone in the horizontal and vertical dimensions is equal to P and Q times the number of positions of the block of input values in the horizontal and vertical dimensions, wherein P and Q are integers. For example, let it be assumed that the input block comprises 32 times 32 positions. In this case, the aligned rectangular box [MABOX] may designate a zone in the departure space comprising, for example, 32 times 32 positions, 32 times 64 positions, 64 times 32 positions or 64 times 32 positions. The extension of the extended rectangular box [EBBOX] towards the aligned rectangular box [MABOX] thus facilitates the filling of the object memories [OM] shown in FIG. 10.

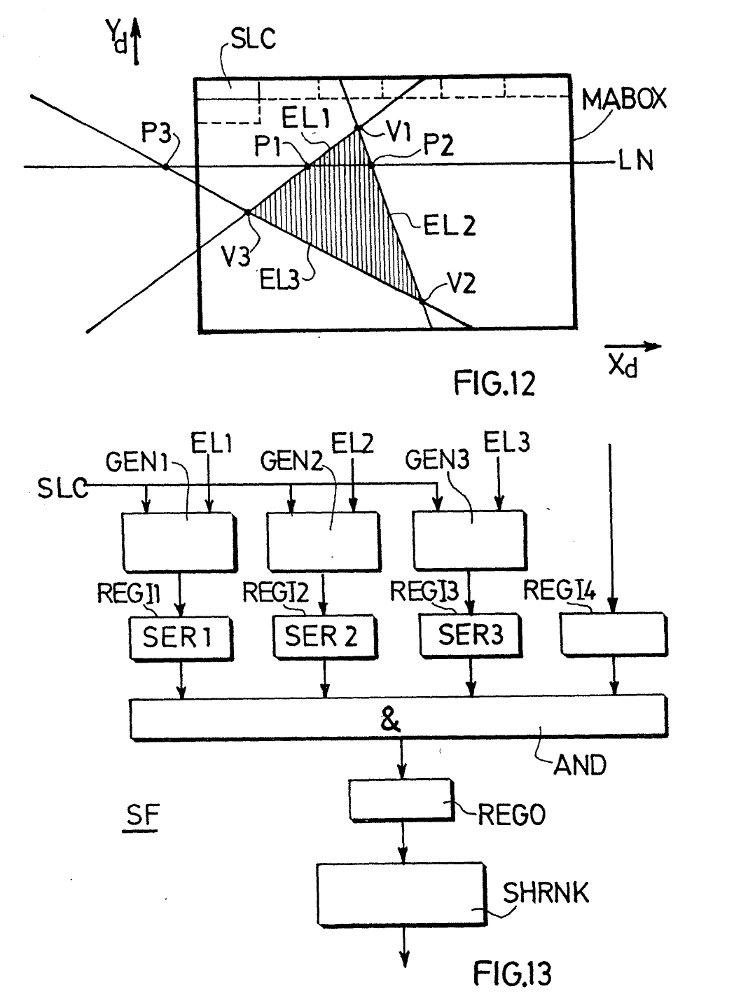

FIG. 12 illustrates an aligned rectangular box [MABOX] which comprises the surface of a 3D graphic element. Geometrical parameters define the triangular surface. The geometrical parameters may be, for example, the co-ordinates of the apexes of the angles [V] of the triangular surface. The geometrical parameters also define three edge lines: a first edge line [EL1], a second edge line [EL2] and a third edge line [EL3]. An edge line [EL] cuts the aligned rectangular box [MABOX] into two parts: a part which does not comprise the surface and another part which comprises the surface.

A line [LN] in the departure space is characterized by a vertical co-ordinate (x_{d}). On each line, there are three edge line points: a first edge line point [P1], a second edge line point [P2] and a third edge line point [P3]. The first edge line point [P1] is the horizontal co-ordinate (x_{d}) of the first edge line [EL1] being given by the vertical co-ordinate (x_{d}) of the line [LN]. The second edge line point [P2] and the third edge line point [P3] are the horizontal co-ordinate (x_{d}) of the second edge line [EL2] and the horizontal co-ordinate (x_{d}) of the third edge line [EL3], respectively, being given by the vertical co-ordinate (y_{d}) of the line [LN].

The shape former [SF] indeed scans the aligned rectangular box [MABOX] line by line. More in detail, the shape former [SF] scans a line slice by slice. A slice [SLC] is a series of M consecutive positions in the horizontal dimension. For each slice [SLC], the shape former [SF] generates Boolean input values. The shape memory [SM] is used for temporarily storing the Boolean input values. The generation of the Boolean input values has already been described in a conceptual manner with reference to FIGS. 7a to 8c. It will again be described hereinafter in greater detail.

For each different slice [SLC], the shape former [SF] establishes three series of Boolean values. The shape former [SF] establishes a first series of Boolean values (SER1) from the first edge line [ELI], a second series of Boolean values (SER2) from the second edge line [EL2] and a third series of Boolean values (SER3) from the third edge line [EL3]. A series (SER) comprises a Boolean value for each position comprised in the slice [SLC]. It has already been explained that an edge line [EL] cuts the aligned rectangular box [MABOX] into two parts. The Boolean value indicates whether the position concerned is in one or the other part of the aligned rectangular box [MABOX].

The shape former [SF] establishes a series of Boolean values as follows. The shape former [SF] computes the distance between the left extremity of the slice [SLC] and the edge line point [P] concerned. This distance will hereinafter be referred to as left distance (Dist_L). The shape former [SF] also computes the distance between the right extremity of the slice [SLC] and the edge line point [P] concerned. This distance will hereinafter be referred to as right distance (Dist_R). The series of Boolean values (SER) is a function (F) of the left distance and the right distance: SER=F(Dist_L, Dist_R).

If the left distance (Dist_L) and the right distance (Dist_R) have the same sign, the series (SER) will be constituted by identical Boolean values. This means that, as a function of the sign, the series (SER) will be exclusively constituted by Boolean values which are equal to zero (0) or will be exclusively constituted by Boolean values which are equal to one (1). If the left distance (Dist_L) and the right distance (Dist_R) have opposite signs, the edge line point [P] is indeed present in the slice [SLC] concerned. In this case, the first part of the series (SER) will be constituted by Boolean values which are equal to zero (0) and the second part will be constituted by Boolean values which are equal to one (1), or the inverse. The size of the one and the other part is a function (F) of the left and right distances (Dist_L, Dist_R).

The function (F) may be implemented, for example, by means of the logic circuit and a memory comprising a table. In this case, the table comprises the different series of possible Boolean values. An addressing circuit selects the cell of the table comprising the series of Boolean values desired as a function of the left and right distances.

The following method allows an easy computation of the left and right distances. The shape former [SF] computes the three edge line points [P1, P2, P3] for the first line of the aligned rectangular box [MABOX]. The left extremity of the first slice on this line is present on the horizontal reference co-ordinate x_{d}=0. Consequently, the left distance for the first series of Boolean values is equal to the first edge line point (Dist_L/SER1=P1). The left distance for the second series of Boolean values and that for the third series of Boolean values are equal to the second edge line point and to the third edge line point, respectively, (Dist_L/SER2=P2; Dist_L/SER3=P3). For the other slices of the line, the left distance (Dist_L) for a series is equal to the right distance (Dist_R) for the same series relating to the preceding slice. The right distance for a series of Boolean values is always equal to the left distance for the same series minus M (Dist_R=Dist_L−M), wherein M is the number of positions in a slice [SLC].

The shape former [SF] computes the left distances (Dist_L) and the right distances (Dist_R) for the series of Boolean values on the second line and those on the other lines as follows. The shape former [SF] computes the inverse of the slope of each edge line [EL]. For each series of Boolean values on a line, the shape former [SF] takes the left distance (Dist_L) of the series of Boolean values on the preceding line having the same horizontal position. Subsequently, the shape former [SF] adds to this left distance (Dist_L) the inverse of the slope. The result of this computation is the left distance (Dist_L) for the series of Boolean values on the current line. The right distance for a series of Boolean values is always equal to the left distance for the same series minus M (Dist_R=Dist_L−M).

FIG. 13 illustrates some details of the shape former [SF]. The shape former [SF] comprises three Boolean value series generators [GEN], enumerated first to third generators [GEN1, GEN2, GEN3], four input registers [REG1], enumerated first to fourth registers [REGI1, REGI2, REGI3, REGI4], a logic AND circuit [AND] and an output register [REGO] and a compression, or shrinkage, circuit [SHRNK].

The first Boolean value series generator [GEN1] generates the first series of Boolean values (SER1) for the relevant slice [SLC] from the first edge line [EL1]. The second Boolean value series generator [GEN2] and the third Boolean value series generator [GEN3] generate the second series of Boolean values (SER2) and the third series of Boolean values (SER3), respectively, for the relevant slice [SLC] from the second edge line [EL2] and the third edge line [EL3]. It is recalled that the geometrical parameters of a 3D graphic element define the edge lines [EL]. The generation of series of Boolean values (SER) is performed in accordance with the method described hereinbefore. The first series of Boolean values (SER1), the second series of Boolean values (SER2) and the third series of Boolean values (SER3) are placed in the first input register [REGI1], the second input register [REGI2] and the third input register [REGI3], respectively.

The fourth input register [REGI4] is used for storing original S values originating from the relevant set of image sample values. Each slice [SLC] designates a series of M positions in the aligned rectangular box [MABOX] shown in FIG. 12. The set of image sample values may comprise an original S value for each position. In this case, the shape former [SF] writes the M original S values concerned in the fourth input register (REGI4). In contrast, there may be one or several positions in a slice [SLC] for which the set of image sample values does not comprise original S values. At least one part of the slice [SLC] is indeed outside the set of image sample values. In this case, the shape former [SF] writes a Boolean value which is equal to zero (0) into the fourth input register [REGI4] for each position outside the set of input sample values.

If the set does not comprise the original S value, the shape former [SF] writes a Boolean value which is equal to one (1) into the fourth input register [REGI4] for each position within the set and a Boolean value which is equal to zero (0) for each position outside the set. The shape former [SF] knows whether a position is within or outside the set in the following manner. Each position in the aligned rectangular box [MABOX] illustrated in FIG. 11 is associated with a memory address. The shape former [SF] has access to a table indicating for each set of image sample values the memory zone in which the set is stored. The shape former [SF] thus detects whether the address associated with a certain position is within the zone of the memory in which the set concerned is stored, or is outside this zone. If the address is outside the zone, which implies that the position is outside the set, the shape former [SF] writes a Boolean value which is equal to zero (0) into the fourth input register [REGI4].

The logic AND circuit [AND] illustrated in FIG. 13 combines the respective contents of the input registers [REG1] in accordance with the logic AND function. Indeed, for each position in the output register [REGO], the logic AND circuit [AND] takes in each input register [REG1] the Boolean value having the same position and applies the logic AND function to these Boolean values. The contents of the output register [REGO] constitute a series of gross Boolean input values.

The shrinkage circuit [SHRNK] furnishes Boolean input values for storage in the shape memory [SM] from gross Boolean input values in the output register [REGO]. It has already been explained that the controller [CNTRL] illustrated in FIG. 3 may define a compression factor (N). In this case, the shrinkage circuit [SHRNK] indeed divides the output register [REGO] into groups of N consecutive gross Boolean input values. The shrinkage circuit [SHRNK] applies the AND function to each group in order to obtain a Boolean input value.

For example, let it be assumed that the output register [REGO] comprises, at the positions 1, 2, 3 and 4, gross Boolean input values which are equal to 1, 1, 1, and 0, respectively. Let it also be assumed that the compression factor is 2. In this case, the shrinkage circuit [SHRNK] applies the AND function to the gross Boolean input values at the positions 1 and 2 which results in a Boolean input value which is equal to 1. The shrinkage circuit [SHRNK] applies the AND function to gross Boolean input values at the positions 3 and 4, which results in a Boolean input value which is equal to 0. If there is no compression factor, the shrinkage circuit [SHRNK] stores the series of gross Boolean input values as such in the shape memory [SM].

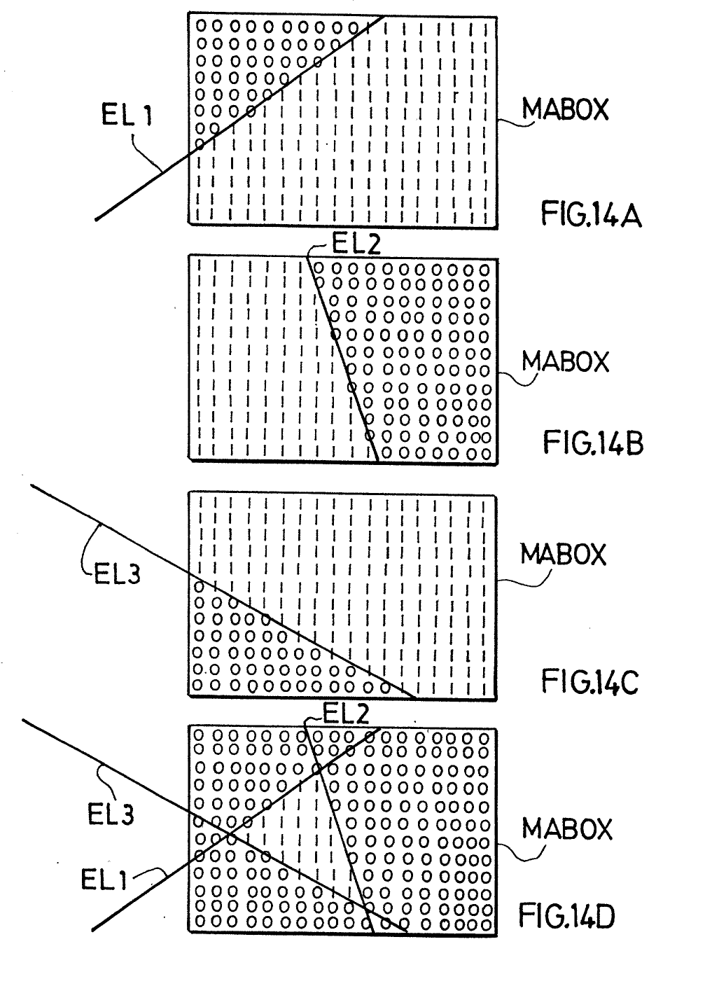

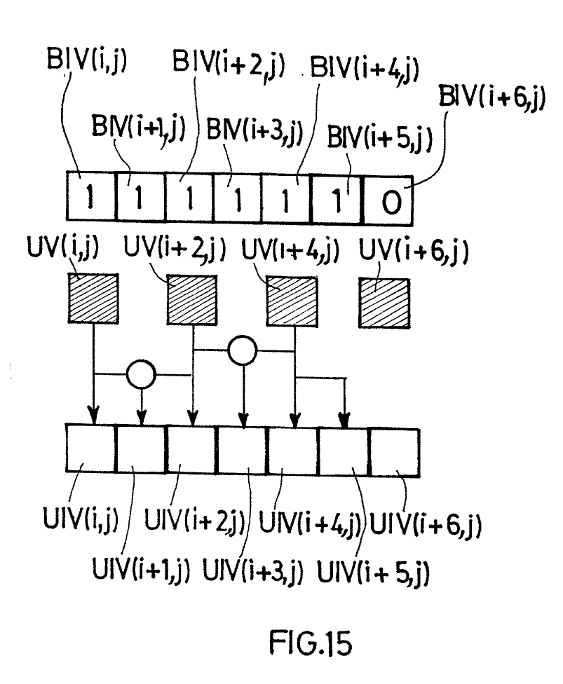

FIGS. 14a, 14b, 14c and 14d illustrate the operation of the shape former [SF]. Each Figure represents a space corresponding to the aligned rectangular box [MABOX]. To simplify these Figures, it is supposed that the aligned rectangular box [MABOX] comprises 8 times 8 positions. The first edge line [EL1], the second edge line [EL2] and the third edge line [EL3] already illustrated in FIG. 12 are reproduced in FIGS. 14a, 14b and 14c, respectively. These edge lines define the surface already illustrated in FIG. 12. This surface is reproduced in FIG. 14d.

FIGS. 14a, 14b and 14c illustrate the set of first series of Boolean values, the set of second series of Boolean values and the set of third series of Boolean values, respectively, generated with respect to the aligned rectangular box [MABOX]. FIG. 14d illustrates the result obtained by applying the logic AND function to the sets illustrated in FIGS. 14a, 14b and 14c. This result constitutes the gross Boolean input values from which the input values are established by performing a compression, if necessary.

The operation of the object former [OF] illustrated in FIG. 10 will hereinafter be described in greater detail. The object former [OF] performs, via the random access memory [DMA], a reading operation in the memory [MEM] illustrated in FIG. 3. This reading operation relates to the original Y, U, V and A values which are present in the zone of the departure space designated by the aligned rectangular box [MABOX] illustrated in FIG. 11. The object former [OF] also performs a reading operation in the shape memory [SM]. The object former [OF] thus receives the Boolean input values which the shape former [SF] has generated with respect to the aligned rectangular box [MABOX] as described hereinbefore.

The object former [OF] performs several operations. First, the object former [OF] effects a conversion of the format if the format of the set of image sample values is not in accordance with the format 4:4:4. Secondly, the object former [OF] effects a compression if the controller [CNTRL] defines a compression factor (N). In this case, the object former [OF] takes the average of N neighboring original values so as to obtain an input value. Thirdly, the object former [OF] combines each Boolean input value with the A input value (opacity) having the same position. The object former [OF] thus creates a combined input value which is stored in the relevant object memory [OM]. The combined input value thus comprises a bit which represents the Boolean input value. The other bits represent the A input value (opacity).

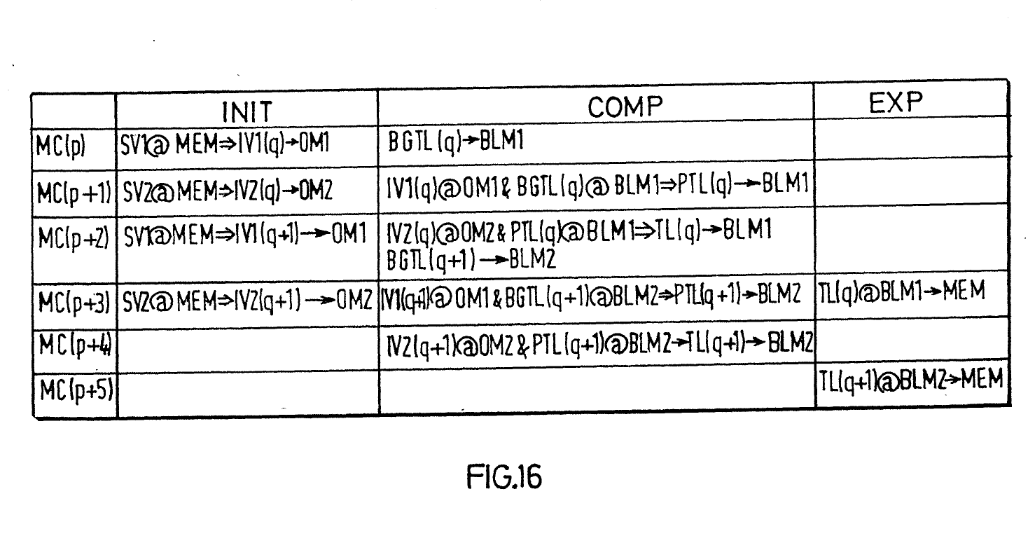

FIG. 15 illustrates a conversion of the format in which the Boolean input values play a role. FIG. 15 illustrates several Boolean input values [BIV(i,j) . . . BIV(i+6,j)] and several original U values [UV(i,j), UV(i+2,j), UV(i+4,j), UV(i+6,j)] which the object former [OF] receives. FIG. 15 illustrates also several U input values [UIV(i,j) . . . UIV(i+5,j)] which the object former [OF] writes into the relevant object memory [OM]. The signs between parentheses represent the position of the value concerned in the form of departure co-ordinates (x_{d}, y_{d}). If a Boolean input value [BIV] is equal to one (1), this indicates that the U input value [UIV] having the same position is valid. In contrast, if a Boolean input value [BIV] is equal to zero (0), this indicates that the U input value [UIV] having the same position is not valid.

FIG. 15 illustrates that for certain U input values [UIV(i,j), UIV(i+2,j), UIV(i+4,j)] there is an original U value [UV(i,j), UV(i,j+2), UV(i,j+4)] with a corresponding position. Each of these U input values [UIV(i,j), UIV(i+2,j), UIV(i+4,j)] is a literal copy of the original U values [UV(i,j), UV(i,j+2), UV(i,j+4)] having the same position.

FIG. 15 also illustrates that certain U input values [UIV(i+1,j), UIV(i+3,j), UIV(i+5,j)] indeed fill holes between the original U values [UV(i,j), UV(i,j+2), UV(i,j+4)]. A hole may be present between original U values [UV(i,j), UV(i+2,j)] which are valid. In this case, the U input value [UIV(i+1,j)] which indeed fills this hole is obtained by interpolation between the two original U values [UV(i,j), UV(i+2,j)] concerned. In contrast, a hole may be present between an original U value [UV(i+4,j)] which is valid and an original U value [UV(i+6,j)] which is not valid. In this case, the U input value [UIV(i+5,j)] which indeed fills this hole is a literal copy of the valid original U value [UV(i+4,j)]. This is done in order that the U input value [UIV(i+5,j)] does not depend on the non-valid original U value [UV(i+6,j)].

The operation of the composition circuit [CCOMP] shown in FIG. 10 will now be described in greater detail. The geometrical transformation circuit [GT] scans the zone which occupies the relevant tile in the arrival space. This scanning has already been described hereinbefore with reference to the composition steps [COMP] illustrated in FIG. 6. For each position (xₐ, yₐ), the geometrical transformation circuit [GT] determines the position of the filter kernel [KRNL] as explained hereinbefore with reference to FIG. 9. The geometrical transformation circuit [GT] causes the filter former [FIF] to search in the object memory M the input values which are present in the filter kernel [KRNL]. The geometrical transformation circuit [GT] also causes the interpolation circuit [IP] to read the appropriate filter coefficients of the coefficient memory [COM]. The filter coefficients depend on the fractional part (Δx_{d}, Δy_{d}) of the departure co-ordinates (x_{d}, y_{d}) which define the center of the filter kernel. This has been explained hereinbefore with reference to FIG. 9.

The filter former [FIF] illustrated in FIG. 10 rearranges the input values in order that their positions correspond to the filter coefficients. The filter former [FIF] also replaces all non-valid input values by values based on valid input values. The filter former [FIF] thus prevents a non-valid input value from contributing to the tile, which would otherwise cause a distortion. It is recalled that the Boolean input values which are comprised in the combined input values indicate which input values are valid and which are not. For example, the filter former [FIF] may establish the median value of all the valid Y input values in the filter kernel. Subsequently, the filter former [FIF] replaces the non-valid Y input values by the median value of the valid Y input values. The filter former [FIF] performs similar operations for the U, V and A input values.

The interpolation circuit [IP] shown in FIG. 10 comprises two polyphase filters: a first polyphase filter for the Y, U and V input values and a second polyphase filter for the combined input values, each of which comprises an A input value and a Boolean input value. Each filter comprises 4 times 4 taps. Each tap is associated with a filter coefficient and an input value. The first polyphase filter establishes a weighted combination of the input values supplied by the filter former [FIF]. This filter thus establishes Y, U and V contribution values. The second polyphase filter derives an A contribution value and a Boolean contribution value from combined input values in the kernel of the filter.

The blending circuit [BL) selects one of the two blending memories [BLM1, BLM2] for composing the tile. The background tile [BGTL], the intermediate tiles [PTL] and the tile [TL] shown in FIG. 6 are thus temporarily stored in the selected blending memory [BLM1, BLM2]. The other blending memory [BLM2, BLM1] will be selected for composing the next tile, etc. The blending memories [BLM1, BLM2] are two-port memories. The blending circuit [BL] can thus read a data of a blending memory and simultaneously write a data into the same blending memory.

The blending circuit [BL] receives Y, U, V and A contribution values from the interpolation circuit [IP] and a Boolean contribution value for each position (xₐ, yₐ) of the tile to be composed. The blending circuit [BL] will search, in the selected blending memory [BLM1, BLM2], the Y, U and V samples having the same position (xₐ, yₐ).

The blending circuit [BL] verifies by means of the Boolean contribution value if the Y, U, V and A contribution values are valid or not. If the Y, U, V and A contribution values are valid, the blending circuit [BL] establishes weighted combinations of the Y, U and V contribution values with Y, U and V samples, respectively, originating from the selected blending memory [BLM1, BLM2]. The A contribution value determines the weighting factors. The results of these weighted combinations constitute new Y, U and V samples. The blending circuit [BL] writes these new samples into the selected blending memory [BLM1, BLM2]. If the Y, U, V and A contribution values are non-valid, the blending circuit [BL] rewrites the Y, U, V samples in the selected blending memory [BLM2, BLM1], which samples have been read previously by the same memory. In this case, the new Y, U and V samples are equal to the old Y, U and V samples, respectively.

FIG. 16 illustrates, in the form of a table, the operation of the processor [PRC] shown in FIG. 10. The lines of the table represent macrocycles enumerated p^{th} to p+5^{th} [MC(p)−MC(p+5)]. A macrocycle is a time interval comprising a certain number of clock cycles. The columns of the table represent the different steps for generating a tile. The initialization step [INIT] and the composition step [COMP] have been described with reference to FIG. 6. FIG. 16 also illustrates an expedition step [EXP].

FIG. 16 illustrates the generation of two tiles: a q^{th} tile [TL(q)] and a q+1^{th} tile [TL(q+1)]. The processor [PRC] generates each of these tiles from a first set of image sample values [SV1] and a second set of image sample values [SV2].

In the p^{th} macrocycle [MC(p)], the initialization circuit [CINIT] generates a first block of input values for the q^{th} tile [IV1 (q)] from the first set of image sample values [SV1]. This block [IV1(q)] is stored in the first object memory [OM1]. Simultaneously, the composition circuit [CCOMP] places background samples for the q^{th} tile [BGTL(q)] in the first blending memory [BLM1].

In the p+1^{th} macrocycle [MC(p+1)], the initialization circuit [CWNIT] generates a second block of input values for the q^{th} tile [IV2(q)] from the second set of image sample values [SV2]. This block [IV2(q)] is stored in the second object memory [OM2]. Simultaneously, the composition circuit [CCOMP] reads the first block of input values for the q^{th} tile [IV1(q)] of the first object memory [OM1] and generates contribution values from this block. The composition circuit [CCOMP] combines the contribution values and the background samples for the q^{th} tile [BGTL(q)] for forming intermediate image samples for the q^{th} tile [PTL(q)]. These intermediate image samples [PTL(q)] are stored in the first blending memory [BLM1].

In the p+2^{th} macrocycle [MC(p+2)], the initialization circuit [CINIT] generates a first block of input values for the q+1^{th} tile [IV1 (q+1)] from the first set of image sample values [SV1]. This block [IV1(q+1)] is stored in the first object memory [OM1]. Simultaneously, the composition circuit [CCOMP] reads the second block of input values for the q^{th} tile [IV2(q)] of the second object memory [OM2] and generates contribution values from this block. The composition circuit [CCOMP] combines the contribution values and the intermediate samples for the q^{th} tile [PTL(q)] which are stored in the first blending memory (BLM1]. The composition circuit [CCOMP] thus generates image samples for the q^{th} tile [TL(q)]. It stores the image samples in the first blending memory [BLM1]. The first blending memory [BLM1] thus comprises the q^{th} tile [TL(q)] at the end of the p+2^{th} macrocycle [MC(p+2)]. Finally, the composition circuit [CCOMP] places background samples for the q+1^{th} tile [BGTL(q+1)] in the second blending memory [BLM2].

In the p+3^{th} macrocycle [MC(p+3)], the initialization circuit [CINIT] generates a second block of input values for the q+1^{th} tile [IV2(q+1)] from the second set of image sample values [SV2]. This block [IV2(q+1)] is stored in the second object memory [OM2]. Simultaneously, the composition circuit [CCOMP] reads the first block of input values for the q+1^{th} tile [IV1(q+1)] of the first object memory [OM1] and generates contribution values from this block. The composition circuit [CCOMP] combines the contribution values and the background samples for the q+1^{th} tile [BGTL(q+1)] for forming intermediate samples for the q+1^{th} tile [PTL(q+1)]. These intermediate image samples are stored in the second blending memory [BLM2]. The processor [PRC] transfers the q^{th} tile [TL(q)] of the first blending memory [BLM1] to the memory [MEM] shown in FIG. 3.

In the p+4^{th} macrocycle [MC(p+4)], the initialization circuit [CINIT] reads a second block of input values for the q+1^{th} tile [IV2(q+1)] of the second object memory [OM2] and generates contribution values from this block. The composition circuit [CCOMP] combines the contribution values and the intermediate samples for the q+1^{th} tile [PTL(q+1)] which are stored in the second blending memory [BLM2]. The composition circuit [CCOMP] thus generates image samples for the q+1^{th} tile [TL(q+1)]. It stores the image samples in the second blending memory [BLM2]. The second blending memory [BLM2] thus comprises the q+1^{th} tile [TL(q+1)] at the end of the p+4^{th} macrocycle [MC(p+4)]. In the p+5^{th} macrocycle [MC(p+5)], the processor [PRC] transfers the q+1^{th} tile [TL(q+1)] of the second blending memory [BLM2] to the memory [MEM] shown in FIG. 3.

In a single macrocycle, the processor [PRC] can thus perform three different steps: initialization [INIT], composition [COMP] and expedition [EXP]. The first object memory [OM1] and the second object memory [OM2] operate in the flip-flop mode in the rhythm of the macrocycles [MC]. In a certain macrocycle, one of these two memories is a receiver of data, while the other memory is a transmitter of data. In principle, the roles are inversed every macrocycle [MC]. The first blending memory [BLM1] and the second blending memory [BLM2] also operate in the flip-flop mode, but in the rhythm of the tiles [TL]. The processor [PRC] uses one of these two memories for composing a certain tile and it uses the other memory for composing the subsequent tile.

The image composition device described hereinbefore with reference to FIGS. 3 to 16 is an example of implementing characteristics shown in FIGS. 1 and 2. Particularly FIGS. 7a, 7b and 7c illustrate the generation of Boolean input values, a Boolean input value having a certain position in the departure space and designating the other values having the same position as being non-valid if the position is outside the set of image sample values.

The description above with reference to different Figures illustrates rather than limits the invention. It will be evident that there are numerous alternatives which fall within the scope of the appendant claims. In this respect, several remarks will be made in conclusion.

There are numerous ways of composing an image according to the invention. The device shown in FIG. 3 composes an image by successively generating tiles. In principle, it is also possible to compose an image, for example, in one operation. This is possible if the internal memories [SM, OM, BLM] of the processor shown in FIG. 10 are sufficiently large.

There are numerous ways of implementing functions by means of items of hardware or software or a combination of both. In this respect, the Figures are very diagrammatic and each Figure represents only an embodiment. Although a Figure shows different functions in the form of separate blocks, it does not at all exclude the fact that a single item of hardware or software performs several functions. This neither excludes the fact that a function can be performed by a set of hardware or software items.

The processor shown in FIG. 10 comprises, for example, different blocks which, in combination, generate tiles. In principle, it is possible to implement these blocks by means of a suitably programmed computer circuit. A set of instructions contained in a programming memory may cause the computer circuit to perform the different operations described hereinbefore with reference to FIGS. 3 to 16. The set of instructions may be loaded into the programming memory by reading a data carrier such as, for example, a disc which comprises the set of instructions. The reading operation may be performed by means of a communication network such as, for example, the Internet. In this case, the service provider puts the set of instructions at the disposal of those interested.

No reference sign between parentheses in a claim shall be interpreted in a limitative manner. Use of the verb “comprise” and its conjugations does not exclude the presence of elements or steps other than those stated in a claim. Use of the article “a” or “an” preceding an element or a step does not exclude the presence of a plurality of these elements or steps.

1. A method of composing an image [IM], the method comprising a step of mapping [MAP] a set of image sample values [SV] from a departure space [DEP] to an arrival space [ARR] in accordance with a geometrical transformation [T], the method comprising the steps of
computing a zone in the departure space [ITL] by applying the inverse geometrical transformation [T⁻¹] to a zone in the arrival space [TL] covering a group of image samples;
establishing a group of input values [IV] for the zone in the departure space [ITL], the group of input values [IV] comprising Boolean values [BV], a Boolean input value having a certain position (x_{d}, y_{d}) in the departure space and designating the other values having the same position as being non-valid if the position is outside the set of image sample values;
composing the group of image samples [TL] from the group of input values [IV], the Boolean values [BV] preventing the input values designated as being non-valid from contributing to an image sample.

2. A device for composing an image [IM], the composition comprising a step of mapping [MAP] a set of image sample values [SV] from a departure space [DEP] to an arrival space [ARR] in accordance with a geometrical transformation [T], the device being arranged to perform the steps of
computing a zone in the departure space [ITL] by applying the inverse geometrical transformation [T⁻¹] to a zone in the arrival space [TL] covering a group of image samples;
establishing a group of input values [IV] for the zone in the departure space [ITL], the group of input values [IV] comprising Boolean values [BV], a Boolean input value having a certain position (x_{d}, y_{d}) in the departure space and designating the other values having the same position as being non-valid if the position is outside the set of image sample values;
composing the group of image samples [TL] from the group of input values [IV], the Boolean values [BV] preventing the input values designated as being non-valid from contributing to an image sample.

3. A computer program product for an image composition device, the computer program product comprising a set of instructions which, when loaded into the image composition device, cause the device to map [MAP] a set of image sample values [SV] from a departure space [DEP] to an arrival space [ARR] in accordance with a geometrical transformation [T] by performing the steps of
computing a zone in the departure space [ITL] by applying the inverse geometrical transformation [T⁻¹] to a zone in the arrival space [TL] covering a group of image samples;
establishing a group of input values [IV] for the zone in the departure space [ITL], the group of input values [IV] comprising Boolean values [BV], a Boolean input value having a certain position (x_{d}, y_{d}) in the departure space and designating the other values having the same position as being non-valid if the position is outside the set of image sample values;
composing the group of image samples [TL] from the group of input values [IV], the Boolean values [BV] preventing the input values designated as being non-valid from contributing to an image sample.
